(19) United States
(12) Patent Application Publication
(10) Pub. No.: US 2024/0162449 A1
(43) Pub. Date: May 16, 2024

(54) Electrode plate, a cell, and a lithium battery

(71) Applicant: JIANGSU ZENERGY BATTERY TECHNOLOGIES CO., LTD., Jiangsu (CN)

(72) Inventors: Juntai LU, Jiangsu (CN); Jianliang WEI, Jiangsu (CN); Wuyuan ZOU, Jiangsu (CN)

(21) Appl. No.: 18/388,752

(22) Filed: Nov. 10, 2023

(30) Foreign Application Priority Data
Nov. 11, 2022 (CN) 202211414690.6

(51) Int. Cl. H01M 4/66

(52) U.S. Cl. CPC H01M 4/667; H01M 4/661; H01M 4/663; H01M 4/668

(57) ABSTRACT

The present disclosure relates to the technical field of batteries, and discloses an electrode plate, a cell and a lithium battery. The electrode plate comprises a support layer, a conductive coating layer and an active material layer, wherein at least part of the area of the surface of at least one side of the support layer is coated with the conductive coating layer, and at least part of the area of the surface of a side of the conductive coating layer away from the support layer is covered with the active material layer. The electrode plate provided by the present disclosure has a high production efficiency, a low production difficulty and low production costs.

### TECHNICAL FIELD

The present disclosure relates to the field of battery technologies, and in particular, to an electrode plate, a cell, and a lithium battery.

### BACKGROUND

Currently, in order to prevent a short circuit caused by a needle stick, an electrode plate on the market generally uses an insulating base formed of a polymer material as a support layer, a composite current collector is formed by fully plating both sides of the support layer with metal plating layers, and then an active material is coated on the surface of the two sides of the composite current collector.

The production efficiency of fully plating the metal coating layers on the surface of the support layer is low, the operation is difficult, and the costs of the metal material of the metal coating are relatively high, resulting in high production costs of an electrode plate.

### SUMMARY

An object of the present disclosure is to provide an electrode plate, which has the characteristics of a high production efficiency, a low production difficulty and low production costs.

Another object of the present disclosure is to provide a cell, which has the characteristics of a high production efficiency, a low production difficulty and low production costs.

Another object of the present disclosure is to provide a lithium battery, which has the characteristics of a high production efficiency, a low production difficulty and low production costs.

An embodiment of the present disclosure provides a technical solution:

An electrode plate, comprising a support layer, a conductive coating layer and an active material layer, wherein at least part of the area on the surface of at least one side of the support layer is coated with the conductive coating layer;

At least part of the area on the surface of a side of the conductive coating layer away from the support layer is coated with the active material layer.

Further, the conductive coating layer completely covers a side corresponding to the support layer, and the active material layer partially covers a side of the conductive coating layer away from the support layer;

The electrode plate further comprises metal tabs, and the metal tabs are laid on an area which is not covered by the active material layer on a side of the conductive coating layer away from the support layer.

Further, the conductive coating layer partially covers a side corresponding to the support layer;

The electrode plate further comprises a metal plating layer, and the metal plating layer is laid on the area which is not covered by the conductive coating layer on the surface of at least one side of the support layer.

Further, on the same side of the support layer, the two conductive coating layers are respectively coated on two opposite sides of the support layer, and the metal plating layer is laid on the area between the two conductive coating layers.

Further, the active material layer completely covers a side of the metal plating layer away from the support layer, and partially covers the two conductive coating layers;

The electrode plate further comprises metal tabs, and the metal tabs are laid on the area which is not covered by the active material layer on a side of each of the two conductive coating layers away from the support layer.

Further, on the same side of the support layer, the two metal plating layers are respectively laid on opposite sides of the support layer, and the area between the two metal plating layers is coated with the conductive coating layer.

Further, two opposite sides of the conductive coating layer respectively partially cover a side of each of the two metal coatings away from the support layer, and the active material layer completely covers the conductive coating layer.

Further, the conductive coating layer comprises a conductive material and an adhesive, wherein the mass ratio of the conductive material is 45%-90%, and the mass ratio of the adhesive is 10%-55%; and the conductive material comprises a carbon-containing material and a metal powder, wherein the mass ratio of the carbon-containing material in the conductive material is 55%-90%, and the mass ratio of the metal powder in the conductive material is 10%-45%.

Further, the support layer is a polymeric material, and the surface of the support layer is nano-treated.

Further, the thickness of the support layer is in the range from 2 μm to 10 μm, and the thickness of the conductive coating layer is in the range from 0.5 μm to 15 μm.

An embodiment of the present disclosure further provides a cell, comprising the electrode plate, wherein the electrode plate comprises a support layer, a conductive coating layer and an active material layer, at least part of the area of the surface of at least one side of the support layer is coated with the conductive coating layer; and at least part of the area of the surface of a side of the conductive coating layer away from the support layer is covered with the active material layer.

An embodiment of the present disclosure further provide a lithium battery, comprising the cell, wherein the cell comprises the electrode plate, wherein the electrode plate comprises a support layer, a conductive coating layer and an active material layer, at least part of the area of the surface of at least one side of the support layer is coated with the conductive coating layer; and at least part of the area of the surface of a side of the conductive coating layer away from the support layer is covered with the active material layer.

Compared with the prior art, in the electrode plate provided by the present disclosure, a conductive coating layer is coated on at least part of the area of the surface of at least one side of the support layer, and by partially or completely replacing a metal plating layer by the method of coating the conductive coating layer on the surface of the support layer, the coating operation has a low difficulty, the amount of the metal material is reduced, and thus the production efficiency of the electrode plate can be significantly improved, the production difficulty is greatly reduced, and the production costs are reduced. Therefore, beneficial effects of the electrode plate provided by the present disclosure comprise: high production efficiency, the production difficulty is low, and the production cost is low.

### BRIEF DESCRIPTION OF THE DRAWINGS

In order to illustrate the technical solutions of the embodiments of the present disclosure more clearly, the following will briefly introduce the drawings used in the embodiments. It should be understood that the following drawings only illustrate certain embodiments of the disclosure and therefore should not be considered as limiting the scope. For those skilled in the art, other related drawings can also be obtained based on these drawings without creative effort.

FIG. 1 is a schematic structural view showing an electrode plate provided in embodiment 1 of the present disclosure;

FIG. 2 is a schematic structural view showing an electrode plate provided in embodiment 2 of the present disclosure;

FIG. 3 is a schematic structural view showing an electrode plate provided in embodiment 3 of the present disclosure;

Reference sign: 100—electrode plate; 110—support layer; 120—conductive coating layer; 130—active material layer; 140—metal tab; 150—metal plating layer.

### DETAILED DESCRIPTION OF THE EMBODIMENTS

To make the objects, technical solutions, and advantages of the embodiments of the present disclosure clearer, the following clearly and fully describes the technical solutions in the embodiments of the present disclosure with reference to the accompanying drawings in the embodiments of the present disclosure. Apparently, the embodiments described are a part rather than all of the embodiments of the present disclosure. The components of the embodiments of the present disclosure generally described and illustrated in the accompanying drawings herein may be arranged and designed in a variety of different configurations.

Accordingly, the following detailed description of the embodiments of the disclosure provided in the accompanying drawings is not intended to limit the scope of the disclosure, but merely represents selected embodiments of the disclosure. Based on the embodiments of the present disclosure, all other embodiments obtained by those of ordinary skill in the art without creative efforts fall within the scope of protection of the present disclosure.

It should be noted that like reference signs and letters represent like items in the following accompanying drawings, and thus, once an item is defined in one drawing, it does not require further definition and explanation in subsequent drawings.

In the description of the present disclosure, it should be understood that, orientation or position relationships indicated by terms such as “upper”, “lower”, “inner”, “outer”, “left” and “right” are orientation or position relationships based on the accompanying drawings, or orientation or position relationships of a product of the present disclosure which is conventionally placed in use, or orientation or position relationships which are conventionally understood by those skilled in the art, and are merely for the convenience of describing the present disclosure and simplifying the description, and does not indicate or imply that the referred device or element must have a specific orientation and be constructed and operated in a specific orientation, and thus cannot be understood as a limitation of the present disclosure.

In addition, terms such as “first” and “second” are only used for distinguishing descriptions, and cannot be understood as indicating or implying relative importance.

In addition, in the description of the present disclosure, it should be noted that, unless specified or limited otherwise, terms such as “setting” and “connection” should be understood broadly, for example, “connection” may be a fixed connection, a detachable connection, or an integral connection; may be a mechanical connection, or may be an electrical connection; may be a direct connection, may also be an indirect connection via an intervening structure, and may be an inner communication between two elements. The specific meanings of the terms above in the present disclosure can be understood by those skilled in the art according to specific situations.

Specific embodiments of the present disclosure will be described in detail below with reference to the accompanying drawings.

### Embodiment 1

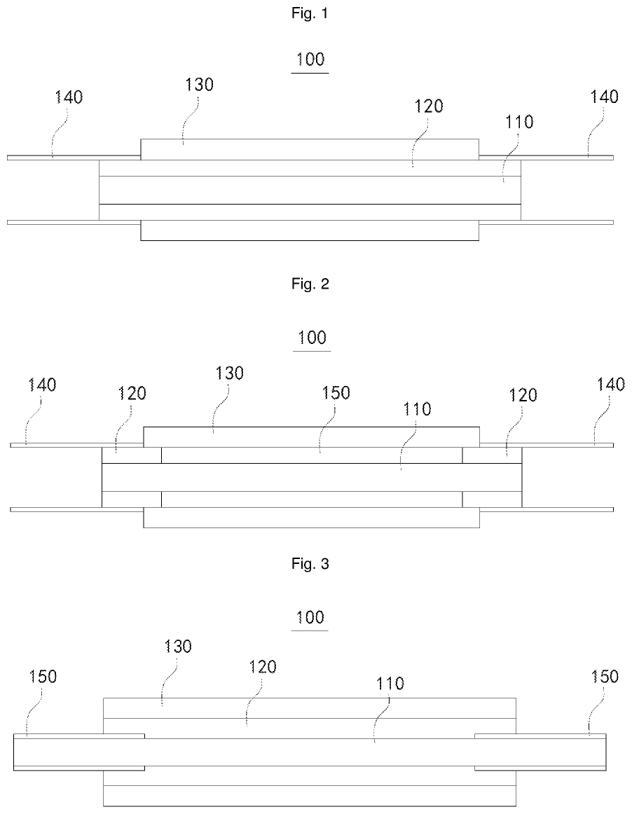

Reference was made to FIG. 1, and the FIG. 1 was a schematic structural view of an electrode plate 100 provided in this embodiment.

The electrode plate 100 provided in this embodiment comprised a support layer 110, conductive coating layers 120, active material layers 130 and metal tabs 140.

The conductive coating layer 120 was completely coated on the surface of both sides of the support layer 110, that was, the conductive coating layer 120 completely replaced the metal plating 150 to completely cover the surface of both sides of the support layer 110.

The two conductive coating layers 120 covering the opposite sides of the support layer 110 were each coated with an active material layer 130 on a side away from the support layer 110, and the two active material layers 130 realized corresponding partial coverage of the two conductive coating layers 120.

In this embodiment, as the conductive coating layer 120 completely replaced the metal plating layer 150, the metal tabs 140 needed to be configured to facilitate subsequent power connection. In this embodiment, the metal tabs 140 were laid on the area of a side of the conductive coating layers 120 away from the support layer 110 that was not covered by the active material layers 130.

In fact, in this embodiment, for the same side of the support layer 110, the active material layer 130 covered a middle area of the conductive coating layer 120, and two opposite edges of the conductive coating layer 120 were exposed and were coated with the metal tabs 140. That was, two metal tabs 140 were laid on the conductive coating layer 120 on any side of the support layer 110, and four metal tabs 140 were laid on both sides of the support layer 110, thereby facilitating subsequent power connection.

The support layer 110 was made of a polymer material, and the surface thereof was subjected to nano treatment. The main component thereof was at least one of polyamide, polyterephthalate, polytetrafluoroethylene, polyimide, polyvinylidene fluoride, polyethylene, polypropylene, polystyrene, polyvinyl chloride, polybutylene terephthalate, poly-p-phenylene terephthamide, poly(ethylene-propylene), polyoxymethylene, an epoxy resin, a phenolic resin, a silicone rubber, and polycarbonate. In addition, the thickness of the support layer 110 was in the range of 2 μm to 10 μm.

The conductive coating layer 120 comprised a conductive material, an adhesive and a functional additive, wherein the mass ratio of the conductive material was 45% to 90%, and the mass ratio of the adhesive was 10% to 55%.

The conductive material may be one of or a mixture of two or more of conductive carbon, a carbon nanotube, active carbon, Ketjen Black, acetylene black, graphene, a graphite sheet, a graphite particle, a carbon fiber, an intermediate carbon microsphere, a metal powder and the like.

In this embodiment, the conductive material comprised a carbon-containing material and a metal powder, wherein the mass ratio of the carbon-containing material in the conductive material was 55% to 90%, and the mass ratio of the metal powder in the conductive material was 10% to 45%.

The adhesive was mainly a polymer material, including polyvinylidene fluoride, polytetrafluoroethylene, carboxymethyl cellulose sodium salt, styrene-butadiene rubber, polyacrylic acid, polyvinyl alcohol, polyacrylate, an organic silicon resin, an epoxy resin, polyurethane, a phenolic resin, a polyimide resin, an ethylene-acrylic acid copolymer, an ethylene-vinyl acetate copolymer, and an acrylonitrile multi-component copolymer.

The specific components of the functional additive could be selected according to practical application requirements, and can comprise a conductive assistant, a heat dissipation assistant, etc., and the conductive assistant can comprise lithium perchlorate, an organic boron complex lithium salt, an amine salt compound, etc.

In addition, on either side of the support layer 110, the thickness of the conductive coating layer 120 was in the range of 0.5 μm to 15 μm, and was preferably 1 μm in this embodiment, and the thickness of the metal tabs 140 was in the range of 3 μm to 20 μm. When the electrode plate 100 provided in this embodiment was a positive electrode plate, the active material layer 130 was a positive electrode active material, and an aluminum foil material having a thickness of 10 μm was selected as the metal tabs 140. When the electrode plate 100 was a negative electrode plate, the active material layer 130 was a negative electrode active material, and a copper foil material having a thickness of 4.5 μm was selected as the metal tabs 140.

In addition, in practical applications, the metal tabs 140 may be bonded by coating a conductive adhesive on the conductive coating layers 120, or the metal tabs 140 may be directly laminated on the conductive coating layers 120 by hot roller rolling, and the active material layers 130 may be formed by coating an active material of a corresponding polarity.

In summary, in the electrode plate 100 provided in this embodiment, a method in which the surface of the support layer 110 was completely coated with the conductive coating layer 120 completely replaced the fully-plated metal plating layer 150 in the prior art, so that the production efficiency of the electrode plate 100 was improved to the maximum extent, the production difficulty was greatly reduced, and the production costs are reduced.

### Embodiment 2

Reference was made to FIG. 2, and the FIG. 2 was a schematic structural view of an electrode plate 100 provided in this embodiment.

The electrode plate 100 provided in this embodiment comprised a support layer 110, conductive coating layers 120, active material layers 130, metal plating layers 150 and metal tabs 140.

The conductive coating layers 120 were partially coated on the surface of both sides of the support layer 110, and the metal plating layers 150 were laid on the area on the surface of both sides of the support layer 110 which was not covered by the conductive coating layer 120. Actually, the metal plating layers 150 were formed by electroplating. That was, the conductive coating layers 120 partially replaced the metal plating layers 150, and the conductive coating layers 120 realized partial coverage of the surface of both sides of the support layer 110.

In this embodiment, on the same side of the support layer 110, two conductive coating layers 120 were respectively coated on two opposite sides of the support layer 110, and a metal plating layer 150 was laid between the two conductive coating layers 120.

The two metal plating layers 150 covering opposite sides of the support layer 110 were each coated with an active material layer 130 on a side away from the support layer 110. For the same side of the support layer 110, the active material layer 130 achieved full coverage of the corresponding metal plating layer 150 and partially covered the two conductive coating layers 120.

As in this embodiment, on the same side of the support layer 110, the two conductive coating layers 120 blocked the edge of the metal plating layer 150, it was necessary to configure the metal tabs 140 to facilitate subsequent power connection. In this embodiment, the metal tabs 140 were laid on the area which was not covered by the active material layer 130 on a side of the conductive coating layer 120 away from the support layer 110.

Similarly, in this embodiment, for the same side of the support layer 110, the active material layer 130 fully covered the metal plating layer 150, and the opposite sides of the active material layer 130 respectively covered the sides of the two conductive coating layers 120 closed to the metal plating layer 150, and metal tabs 140 were respectively laid on the outer edges of the two conductive coating layers 120 away from the metal coating 150. That was, the two conductive coating layers 120 on any side of the support layer 110 were respectively coated with metal tabs 140, and a total of four metal tabs 140 were laid on both sides of the support layer 110, which was more convenient for subsequent power connection.

In addition, on either side of the support layer 110, the thickness of the metal plating layer 150 was in the range of 300 nm to 3 μm, and was preferably 1 μm in this embodiment. When the electrode plate 100 provided in this embodiment was a positive electrode plate, the material of the metal plating layer 150 was aluminum; and when the electrode plate 100 was a negative electrode plate, the material of the metal plating layer 150 was copper.

The electrode plate 100 provided in this embodiment differed from embodiment 1 only in that the conductive coating layers 120 were coated on part of the surface of the support layer 110, and the conductive coating layers 120 realized partial replacement of the metal plating layer 150. Features such as the composition and size of the support layer 110, the conductive coating layers 120, the active material layers 130, and the metal tabs 140 were consistent with those of embodiment 1.

In conclusion, in the electrode plate 100 provided in this embodiment, partially replacing the metal plating layer 150 in the prior art by coating the conductive coating layers 120 on the surface of the support layer 110 could improve the production efficiency of the electrode plate 100 to a certain extent, could greatly reduce the production difficulty, and could reduce production costs.

### Embodiment 3

Reference was made to FIG. 3, and the FIG. 3 was a schematic structural view of an electrode plate 100 provided in this embodiment.

The electrode plate 100 provided in this embodiment comprised a support layer 110, conductive coating layers 120, active material layers 130 and metal plating layers 150.

The conductive coating layers 120 were partially coated on the surface of both sides of the support layer 110, and metal plating layers 150 were laid on the area on both sides of the support layer 110 which were not covered by the conductive coating layer 120. Actually, the metal plating layers 150 were formed by electroplating. That was, the conductive coating layers 120 partially replaced the metal plating layers, and the conductive coating layers 120 achieved partial coverage of the surface of both sides of the support layer 110.

In this embodiment, on the same side of the support layer 110, two metal plating layers 150 were respectively laid on the opposite sides of the support layer 110, and a conductive coating layer 120 was coated on the area between the two metal plating layers 150. Furthermore, two opposite sides of the conductive coating layer 120 respectively partially covered one side of each of the two metal plating layers 150 away from the support layer 110.

The two conductive coating layers 120 on the opposite sides of the support layer 110 were each coated with an active material layer 130 on a side away from the support layer 110. For the same side of the support layer 110, the active material layer 130 achieved complete coverage of the corresponding conductive coating layer 120.

In this embodiment, on the same side of the support layer 110, the outer edges of the two metal plating layers 150 away from the conductive coating layer 120 were not covered by the conductive coating layer 120 and the active material layer 130 and were directly exposed outside, which was convenient for subsequent power connection. Therefore, in this embodiment, no additional configuration of metal tabs 140 was required.

The electrode plate 100 provided in this embodiment differed from embodiment 1 in that the conductive coating layers 120 were coated on part of the area of the surface of the support layer 110, and the conductive coating layers 120 realized partial replacement of the metal plating layer 150. The electrode plate 100 provided in this embodiment differed from embodiment 2 in that the positions of the conductive coating layer 120 and the metal plating layer 150 on the surface of the support layer 110 were different. The features such as the composition and size of the metal plating layers 150, the support layer 110, the conductive coating layers 120 and the active material layers 130 were the same as those in embodiment 2.

In addition, embodiments of the present disclosure also compared a plurality of electrode plates 100 provided in the present disclosure with a plurality of existing electrode plates, and the specific conditions were as follows:

Embodiment electrode plate 1: a positive electrode plate, wherein the support layer 110 was PET and had a thickness of 4 μm; the conductive coating layer 120 comprised 59% of conductive carbon and 41% of polyacrylic acid, and comprised no functional additive. The thickness of a single conductive coating layer 120 was 1 μm, the thickness of a single metal plating layer 150 was 1 μm, and the material was aluminum. The structure thereof was as shown in embodiment 3 of FIG. 3. The speed of evaporating the metal plating layer 150 was 500 m/min-700 m/min in a single pass, 20 nm was plated each time, and the plating was performed 50 times in succession, so as to completed 1 μm plating on both side, and the productivity was 10 m/min. The coating speed of the conductive coating layer 120 was 50 m/min-70 m/min.

Embodiment electrode plate 2: a negative electrode plate, wherein the support layer 110 was PET and had a thickness of 4 μm; and the conductive coating layer 120 comprised 59% of conductive carbon and 41% of polyacrylic acid and comprised no functional additive. The conductive coating layer 120 had a thickness of 1 μm on a single side, and the metal plating layer 150 had a thickness of 1 μm on a single side and was made of copper. The structure was as shown in embodiment 3 of FIG. 3. 50 nm copper was plated on the surface of the support layer 110 by means of magnetron sputtering, and then the support layer 110 was thickened to 1 μm by electroplating. In the embodiment, the magnetron sputtering speed of the plating metal layer 150 was 10 m/min, and the electroplating speed was 10 m/min, and the coating speed of the conductive coating layer 120 was 50 m/min-70 m/min.

Embodiment electrode plate 3: a positive electrode plate or a negative electrode plate. The positive electrode plate or the negative electrode plate differed from the embodiment electrode plate 1 and the embodiment electrode plate 2 in respect of the formulation ratio of the conductive coating layer 120. In the embodiment, the conductive coating layer 120 was composed of 21% of conductive carbon, 39% of a carbon nanotube and 40% of polyacrylic acid.

Embodiment electrode plate 4: a positive electrode plate or a negative electrode plate. The positive electrode plate or the negative electrode plate differed from the embodiment electrode plate 1 and the embodiment electrode plate 2 in respect of the formulation ratio of the conductive coating layer 120. In the embodiment, the conductive coating layer 120 was composed of 60% of conductive carbon and 40% of polyacrylic acid.

Embodiment electrode plate 5: a positive electrode plate or a negative electrode plate. The positive electrode plate or the negative electrode plate differed from the embodiment electrode plate 1 and the embodiment electrode plate 2 in respect of the formulation ratio of the conductive coating layer 120. In this embodiment, the conductive coating layer 120 was composed of 70% of a carbon nanotube, 10% of graphene and 20% of polyacrylic acid.

Embodiment electrode plate 6: a positive electrode plate or a negative electrode plate. The positive electrode plate or the negative electrode plate differed from the embodiment electrode plate 1 and the embodiment electrode plate 2 in respect of the formulation ratio of the conductive coating layer 120. In this embodiment, the conductive coating layer 120 was composed of 40% of a carbon nanotube, 40% of graphene and 20% of polyacrylic acid.

Embodiment electrode plate 7: a positive electrode plate or a negative electrode plate. The positive electrode plate or the negative electrode plate differed from the embodiment electrode plate 1 and the embodiment electrode plate 2 in respect of the formulation ratio of the conductive coating layer 120. In this embodiment, the conductive coating layer 120 was composed of 30% of a carbon nanotube, 20% of graphene, 30% of polyacrylic acid, 5% of a conductive assistant and 15% of PVDF.

Embodiment electrode plate 8: a positive electrode plate. The positive electrode plate differed from the embodiment electrode plate 1 in respect of the formulation ratio of the conductive coating layer 120. In this embodiment, the conductive coating layer 120 was composed of 10% of conductive carbon, 30% of a carbon nanotube, 10% of graphene, 10% of an aluminum powder and 40% of polyacrylic acid.

Embodiment electrode plate 9: a negative electrode plate. The negative electrode plate differed from the embodiment electrode plate 1 in respect of the formulation ratio of the conductive coating layer 120. In this embodiment, the conductive coating layer 120 was composed of 10% of conductive carbon, 30% of a carbon nanotube, 10% of graphene, 10% of an aluminum powder and 40% of polyacrylic acid.

Embodiment electrode plate 10: a negative electrode plate. The negative electrode plate differed from the embodiment electrode plate 3 in that the thickness of the conductive coating layer 120 was 2 μm for a single layer, and 4 μm for a total of double layers.

Comparative electrode plate 1: a positive electrode plate, wherein the support layer was PET and had a thickness of 4 μm; the thickness of a single metal plating layer on the support layer was 1 μm, the metal was aluminum, the total thickness of two sides was 2 μm, and the two metal plating layers completely covered the two sides of the support layer. Plating was carried out by evaporation. In this embodiment, the evaporation speed was 500 m/min-700 m/min at a single time, 20 nm was plated each time, and the plating was performed 50 times continuously; and a metal plating layer of 1 μm on each side was completed, and the production capacity was 10 m/min.

Comparative electrode plate 2: a negative electrode plate, wherein the support layer was PET, and the thickness thereof was 4 μm; and the thickness of a metal plating layer plated on the support layer was 1 μm on a single side, the metal was copper, and the thickness of both sides was 2 μm in total. The metal plating layer was firstly plated with 50 nm by means of magnetron sputtering, and then was thickened with 1 μm by electroplating. The magnetron sputtering speed was 10 m/min and the electroplating speed was 10 m/min.

The comparative results were shown in the following table:

| | | Square resistance | | |
|---|---|---|---|---|
| | | of the area where | | |
| | Peel force | the conductive | | |
| | of the | coating layer and | | |
| Embodiment | conductive | the metal | Produc- | |
| electrode | coating | plating layer | tion | Production |
| plates | layer | overlap | rate | costs |
| Embodiment | 13 N/m | 38 | 50 m/min | Compared |
| electrode | | | | with the |
| plate 1 | | | | comparative |
| Embodiment | 15 N/m | 36 | | electrode |
| electrode | | | | plates, the |
| plate 2 | | | | production |
| Embodiment | 13 N/m | 36 | | costs of |
| electrode | | | | each |
| plate 3 | | | | Embodiment |
| Embodiment | 13 N/m | 32 | | electrode |
| electrode | | | | plate were |
| plate 4 | | | | reduced by |
| Embodiment | 8 N/m | 25 | | 60% on |
| electrode | | | | average |
| plate 5 | | | | |
| Embodiment | 5 N/m | 15 | | |
| electrode | | | | |
| plate 6 | | | | |
| Embodiment | 8 N/m | 22 | | |
| electrode | | | | |
| plate 7 | | | | |
| Embodiment | 12 N/m | 23 | | |
| electrode | | | | |
| plate 8 | | | | |
| Embodiment | 12 N/m | 20 | | |
| electrode | | | | |
| plate 9 | | | | |
| Embodiment | 13 N/m | 21 | | |
| electrode | | | | |
| plate 10 | | | | |
| comparative | peeling force | / | produc- | |
| electrode | of the metal | | tion | |
| plate | plating layer | | rate | |
| Comparative | 5 N/m | / | 10 m/min | |
| electrode | | | | |
| plate 1 | | | | |
| Comparative | 5 N/m | / | | |
| electrode | | | | |
| plate 2 | | | | |

It could be determined that the electrode plate 100 provided by the present disclosure had a faster production rate and lower production costs compared with the prior art in which the metal plating layer 150 achieved full coverage. In addition, the peeling force of the conductive coating layer 100 was larger, that was, compared with the metal plating layer 150, the conductive coating 100 was more tightly connected on the support layer 110. In conclusion, in the electrode plate 100 provided by this embodiment, partially replacing the metal plating layer 150 in the prior art by coating the conductive coating layer 120 on the surface of the support layer 110 could improve the production efficiency of the electrode plate 100 to a certain extent, could greatly reduce production difficulty, and could reduce production costs.

Another embodiment of the present disclosure further provided a cell comprising the electrode plate 100 provided by any one of embodiment 1, embodiment 2 and embodiment 3. Therefore, the cell had the characteristics of a high production efficiency, a low production difficulty and low production costs.

In addition, another embodiment of the present disclosure further provided a lithium battery comprising the foregoing cell. It could be understood that the lithium battery also comprised conventional elements and structures such as a housing and a top cover assembly, which were not additionally described herein. Therefore, the lithium battery was also characterized by a high production efficiency, a low production difficulty and low production costs.

The embodiments above were only preferred embodiments of the disclosure and were not intended to limit the disclosure, and for those skilled in the art, the disclosure may have various modifications and variations. Any modifications, equivalent replacements, improvements, etc. made within the spirit and principles of the present disclosure should be included within the scope of protection of the present disclosure.

What is claimed:

1. An electrode plate, comprising a support layer, a conductive coating layer and an active material layer, wherein at least part of the area of the surface of at least one side of the support layer is coated with the conductive coating layer;
at least part of the area of the surface of a side of the conductive coating layer away from the support layer is coated with the active material layer.

2. The electrode plate of claim 1, wherein the conductive coating layer completely covers a side corresponding to the support layer, and the active material layer partially covers a side of the conductive coating layer away from the support layer;
the electrode plate further comprises metal tabs, and the metal tabs are laid on the area not covered by the active material layer on a side of the conductive coating layer away from the support layer.

3. The electrode plate of claim 1, wherein the conductive coating layer partially covers a side corresponding to the support layer;
the electrode plate further comprises a metal plating layer, and the metal plating layer is laid on the area of the surface on at least one side of the support layer not covered by the conductive coating layer.

4. The electrode plate of claim 3, wherein on the same side of the support layer, two conductive coating layers are separately coated on two opposite sides of the support layer, and the metal plating layer is laid on the area between the two conductive coating layers.

5. The electrode plate of claim 4, wherein the active material layers completely cover a side of the metal plating layer away from the support layer and partially cover the two conductive coating layers;
the electrode plate further comprises metal tabs, and the metal tabs are laid on the area which is not covered by the active material layer on a side of each of the two conductive coating layers away from the support layer.

6. The electrode plate of claim 3, wherein two metal plating layers are respectively laid on two opposite sides of the support layer on the same side of the support layer, and the area between the two metal plating layers is coated with the conductive coating layer.

7. The electrode plate of claim 6, wherein two opposite sides of the conductive coating layer respectively partially cover a side of each of the two metal plating layers away from the support layer, and the active material layer completely covers the conductive coating layer.

8. The electrode plate of claim 1, wherein the conductive coating layer comprises a conductive material and an adhesive, the mass ratio of the conductive material is 45%-90%, and the mass ratio of the adhesive is 10%-55%;
the conductive material comprises a carbon-containing material and a metal powder, the mass ratio of the carbon-containing material in the conductive material is 55%-90%, and the mass ratio of the metal powder in the conductive material is 10%-45%.

9. The electrode plate of claim 1, wherein the support layer is a polymeric material, and the surface of the support layer is nano-treated.

10. The electrode plate of claim 1, wherein the thickness of the support layer is in the range of 2 μm to 10 μm; and
the thickness of the conductive coating layer is in a range of 0.5 μm to 15 μm

11. A cell, comprising the electrode plate of claim 1.

12. A lithium battery, comprising the cell of claim 11.

13. A cell, comprising the electrode plate of claim 2.

14. A cell, comprising the electrode plate of claim 3.

15. A cell, comprising the electrode plate of claim 4.

16. A cell, comprising the electrode plate of claim 5.

17. A cell, comprising the electrode plate of claim 6.

18. A cell, comprising the electrode plate of claim 7.

19. A cell, comprising the electrode plate of claim 8.

20. A cell, comprising the electrode plate of claim 9.
